(19) United States
(12) Patent Application Publication
(10) Pub. No.: US 2017/0225639 A1
(43) Pub. Date: Aug. 10, 2017

(54) Dynamic Safety System

(71) Applicant: Desarrollo Techologico Agroindustrial, Cordoba (ES)

(72) Inventors: Fernando Chacon, Cordoba (ES); Gregorio Blanco, Cordoba (ES); Jesus Gil, Cordoba (ES); Mateo Hermosin, Cordoba (ES); Juan Luis Gamarra, Cordoba (ES); Jose Candido Garcia, Sevilla (ES)

(73) Assignee: Desarrollo Techologico Agroindustrial, Cordoba (ES)

(21) Appl. No.: 15/499,533

(22) Filed: Apr. 27, 2017

Related U.S. Application Data
(63) Continuation of application No. 14/531,557, filed on Nov. 3, 2014.
(60) Provisional application No. 61/899,248, filed on Nov. 3, 2013.
(60) Provisional application No. 61/916,798, filed on Dec. 17, 2013.

(51) Int. Cl. B60R 21/0132; G07C 5/08; G05D 1/00; G01S 19/14; B60W 40/08; B60Q 3/80; B60Q 3/70; B60Q 3/60; G07C 5/00; B60W 50/14

(52) U.S. Cl. CPC B60R 21/0132; G07C 5/008; G07C 5/085; G07C 5/0866; G05D 1/0011; B60W 50/14; B60W 40/08; B60Q 3/80; B60Q 3/70; B60Q 3/60; G01S 19/14; B60R 2021/01013

(57) ABSTRACT

A rollover detection system is provided that comprises a device, a sensor and/or a group of sensors and a warning system for use in a vehicle to reduce or prevent the likelihood of a rollover during operation of the vehicle. The rollover detection system can provide a driver of a vehicle, information that informs the driver of the risk and imminence of a rollover and allows the driver to take corrective action to reduce the risk or imminence of a rollover. The rollover detection system can also allow for the review of information collected by a device by a driver or other individual during and after a risk of a rollover is detected.

This is a 35 U.S.C. §111 application is a continuation of U.S. patent application Ser. No. 14/531,557 filed on Nov. 3, 2014, which claims priority pursuant to 35 U.S.C. §119 and is entitled to the filing date of to U.S. Provisional Patent Application 61/899,248, filed Nov. 3, 2013, and U.S. Provisional Patent Application 61/916,798, filed Dec. 1, 2013, each of which is hereby incorporated by reference in its entirety.

In is a fact that during the operation of vehicles that operate on terrain that is not flat or even, such as off-road terrain, accidents occur due to the rollover of the vehicle when it is being used by an individual. Due to the unevenness of the terrain these types of vehicles encounter, there is a high rate of vehicle rollover. For instance, in Spain, there were fifty-six incidents where vehicles rolled over during operation on off-road terrain in 2012. Currently, a method to deal with the rollover problem has relied on devices that use only one parameter, the inclination angle of the vehicle as a reference to establish a rollover limit. These devices are generally placed onboard these vehicles and machinery as an indicator of the inclinations of the vehicle. However, this approach has deficiencies. For instance, inclination is just one factor among several that can result in a rollover and thus, reliance solely on inclination does not result in the removal of the rollover risk. An example, of a device that relies only on inclination is that described in Spanish National Patent Number 201031388. Other factors that can influence stability in a rollover include, without limitation, several parameters, such, as static parameters (inclination) and dynamic parameters.

Currently, there is no known system or device that analyzes in real-time the movement of the vehicle and use its own algorithms to calculate the stability of the vehicle in which it has been placed, taking into account both the static and dynamic effects on the stability, while at the same time providing a warning to the driver in both an effective and intuitive manner regarding the instability resultant from the drivers maneuvers that could lead to a potential rollover risk. Moreover, to the extent that vehicles and machinery, such as, agriculture, forestry and military vehicles, have systems that deal with inclination, these systems generally work by interfering with the engine and drive train—which can cause additional problems, since the terrain status is not known and these actions could make a rollover more likely. This is why these vehicles generally have a button which disconnects stability controls when driving off-road, and agriculture and forestry machinery are not even provided with these advanced systems.

A better way to avoid a situation where a vehicle that is driven off-road, such as, forestry, agriculture and military vehicles, is put is in a position where a rollover may occur is to provide the driver with real-time information that keeps them continually aware of the risk level (which is equal to the loss of stability) of their maneuvers, so that they can apply preventive measures (speed reduction, trajectory change). In addition, it is helpful if the driver is provided an opportunity to learn from issues that have occurred previously and to be provided the ability to train and learn about how to respond to them so that they do not suffer the same issue again or an issue that someone else had that led to a roll-over. Thus, there is a need to provide a driver with a system and device that can warn the driver about a rollover risk and assist the driver in taking a corrective action. The system and device also provide the opportunity to train the driver to acquire objective understanding about the risks and instabilities they may face, so that they can prevent and avoid them in the future.

### SUMMARY

In an aspect of the present invention, a rollover detection system for the dynamic monitoring of the inclination of a vehicle, which system comprises: a device; a sensor and/or a group of sensors; and a warning system. In a further aspect of the present invention, the vehicle is one used in agriculture, military and forestry. In another aspect of the present invention, the rollover detection relies on an analysis of dynamic stability and further, wherein the rollover detection system also relies on inclination, and additionally, wherein the calculation of the stability of the vehicle is based on an analysis of 3-axis accelerations and/or 3-axis angular rates.

In an aspect of the present invention, a sensor or a group of sensors receive GPS data and/or topography data and further wherein, a sensor is a radar, a GPS antenna and a GPS system, a camera or a CCD. In another aspect of the present invention, a sensor provides information to a device for use in calculating a rollover risk. In an aspect of the present invention, a driver selects which sensor data is used to calculate a rollover risk.

In an aspect of the present invention, the device comprises multiple components, including, without limitation, an inclinometer, a combined GPS/GSM device, a central processing unit, a memory device and a means to notify a driver and further, wherein the device further includes a means to protect the drive in case a vehicle rolls over. In an aspect of the present invention, a warning system comprises an alarm and an alarm comprises, without limitation, a siren, a buzzer, a flashing light, a display, a stimuli and/or a voice message. In a further aspect of the present invention, a display comprises two horizontal countered light bar, wherein, without limitation, the lights are light emitting diodes. In another aspect of the present invention, the device includes a means to send information to a third party device, further wherein the third party is a cell phone, a computer system, a personal computer, a computer network, a cloud site, a tablet, a smartphone or a laptop, and additionally wherein, the information sent to a third party device is viewed by a third party user. In an aspect of the present invention, third party user is able to communicate with a driver when a rollover risk is detected and the third party user provides information to a driver to take corrective action and/or remotely takes control of a vehicle to take corrective action to prevent a rollover.

In an aspect of the present invention, the device has a memory to store data and information to a driver or a third party user and further wherein, a third party can copy the data and information stored in the memory to an external memory device. In another aspect of the present invention, the rollover detection system uses information comprising static and dynamic properties of the vehicle in order to calculate vehicle stability and the imminence of a roll over. In another aspect of the present invention, the rollover detection system is able to receive a signal from several components of the vehicle and store their status or value in the register file at each calculation cycle and further wherein, without limitation, the components include an accelerator pedal position, a braking pedal position, a braking system pressure value, a speedometer value, an RPM value, a steering wheel angle, a GPS, an inclinometer and/or a video capture system.

In an aspect of the present invention, the system includes an Automatically Deploying Rollover Protective Structure that can, without limitation, deploy when a rollover is imminent to protect a driver and/or a passenger and/or a component and/or part of a vehicle that is susceptible to damage due to a rollover.

In an aspect of the present invention, information and/or data is used to train a driver or third party how to avoid rolling a vehicle over and/or train a driver or third party to take the appropriate corrective action to avoid a rollover and/or the training takes place in a simulator or a training vehicle.

In an aspect of the present invention, the rollover detection system includes a driver identification system, wherein, and without limitation, the parameters used by the driver identification system are fingerprint sensors, an RFID card identification system, a facial image recognition system and/or any system that can identify the individual driver.

In an aspect of the present invention, the information and/or data is analyzed by software and the results provided to a driver, a third party user or other third party.

In an aspect of the present invention, information and/or data is transmitted to a smartphone, and further wherein the information and/or data is provided in a manner to a driver, a third party user or other third party through an application on the smartphone.

### BRIEF DESCRIPTION OF THE DRAWINGS

FIG. 1 shows a block diagram of the inputs, analysis and outputs of the device.

FIG. 2 shows a depiction of a display bar wherein the display bar shows a rollover risk to the left of the vehicle.

FIG. 3 shows a depiction of the terrain in front of a vehicle as shown on a display.

FIG. 4 shows a pictorial representation of a display of the information and/or data analyzed by the software.

FIG. 5 shows a block diagram of the different elements of a rollover detection system.

FIG. 6 shows a diagram of the functions used to analyze all the data and perform all the functionalities of the rollover detection system.

### DETAILED DESCRIPTION

Aspects of the present specification disclose, in part, a rollover detection system that includes a device that is able to measure several parameters and provide certain features to reduce the possibility of a vehicle, including, without limitation, agriculture, military and forestry vehicles from suffering from a roll-over. As used herein, the rollover detection system relies on a dynamic stability calculation and an analysis system that indicates to a user (hereinafter referred to as a “driver”) the level of stability at each moment and provides a warning to the driver when a situation reaches a threshold where the vehicle is at risk of a rollover allowing the driver to take corrective action.

In another aspect of the present specification, the roll over detection system can be used to train a driver. The training can be used to help a driver objectively assess the risks associated with their maneuvers and provide instruction on how to avoid such risks. In a further embodiment, as the system and device assess a vehicle's stability while driving, for instance, and without limitation, under off-road situations, the system will integrate several integrated or peripheral safety features in order to prevent roll-over and protect both the driver and the vehicle in case a roll-over event occurs.

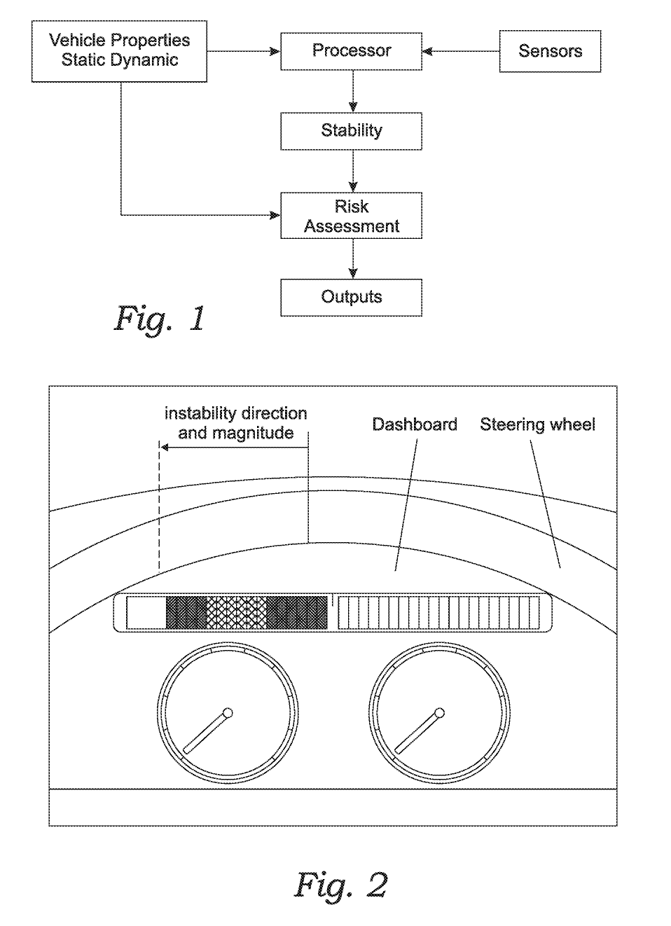

In an embodiment, the functioning of a rollover detection system that includes, without limitation, a device, is described in FIG. 1. As depicted in FIG. 1, the rollover detection system comprises several hardware components, including a device, a sensor and a warning system. The rollover detection system shown in FIG. 1 receives real-time data regarding the inclination and dynamic parameters of a vehicle from a sensor, a group of sensors or groups of sensors, which reflect the movement and behavior of the vehicle or the movable parts that form the vehicle for instance, and without limitation, an articulated vehicle. The sensor data is received by a device that takes the sensor data and uses one or more algorithms to calculate the stability of the vehicle. In this embodiment, the algorithms are able to take the sensor data and other data received by the device, for instance, and without limitation, data received from a global positioning satellite (“GPS”) and/or topography data. The topography data can be obtained from a memory that stores the data in a device or from a cloud site accessed in real time by the device. Using the data, the device can calculate if a threat of a roll over exists for the vehicle.

In an embodiment, an algorithm can work for one or more vehicles. In another embodiment, each vehicle will have an algorithm that is tailored to its specific vehicular characteristics. In another embodiment, an algorithm is influenced by a vehicle's static and inertial (dynamic) properties.

In an embodiment, a vehicle contains one sensor. In a further embodiment, a vehicle contains two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more sensors. In another embodiment, a vehicle contains a group of sensors, wherein, without limitation, the group of sensors are located in a single location in or on the vehicle or the vehicle includes two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more groups of sensors located in two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more locations in or on the vehicle. In an embodiment, a sensor comprises an accelerometer, GPS and/or a gyroscope placed in or on the vehicle and its movable parts.

In another embodiment, a sensor comprises a visual detection system, including, without limitation, a camera, a CCD or other device that allows the device of the rollover detection system to visualize the terrain in front of a vehicle. In a further embodiment, a sensor comprises a visual detection system that allows the rollover detection system to see the terrain in front of a vehicle and to the side and/or to the rear of the vehicle.

In an embodiment, a sensor includes, without limitation, a radar that is mounted in or on a vehicle to allow the radar to map terrain in front of the vehicle and provide a driver with information regarding hazards in the terrain that can result in a rollover of a vehicle. The radar can also, without limitation, be mounted on the side or back of a vehicle. The radar can also be used to detect hazards, including, without limitation, variations of terrain in front, to the side or behind a vehicle.

In an embodiment, the rollover detection system is equipped with a GPS antenna and a GPS system that allows constant tracking of a vehicle in real time. In another embodiment, a GPS system records the location coordinates of the vehicle and stores them in the register file during driving.

In an embodiment, the device includes a GPRS module that can be integrated into the rollover detection system as part of a GPS device or an independent device and the data received can in an embodiment, and without limitation, be sent to a remote server. In an embodiment, the rollover detection system includes a support program, for instance, the INCLISOFT software program for reading and programming the limits and configurations of the equipment via a USB link. The INCLISOFT data-processing application includes a series of functionalities that make it possible to read (from an onscreen display) everything that was stored in the memory of the device, to display all the alarms that were recorded by the device; to empty the register files in the device memory, to copy the register files, to define and modify the stability limits for each alarm level, and/or to change the vehicle model.

In an embodiment, a sensor provides information to a device for use in calculating a rollover risk. In another embodiment, a sensor provides real-time information to a device for use in calculating a rollover risk. In a further embodiment, a vehicle contains two, three, four, five or more different types of sensors. In an embodiment a vehicle contains only one type of sensor. In an embodiment, a driver or a remote user can choose which sensors are used to provide information to a device that calculates a rollover risk. In a further embodiment, a device decides which sensors are used to provide information to a device that calculates a rollover risk.

In an embodiment, a vehicle may have multiple parts. For instance, and without limitation, a vehicle may comprise a driving portion, for example, without limitation, a truck, a pick-up truck, a plough or a tractor and a non-driving portion, for instance, without limitation, a trailer, a hoe and/or a plough. In an embodiment, a trailer is separable from a driving portion. In another embodiment, a trailer is not separable from a driving portion. In a further embodiment, a vehicle is articulated with one or more driving portions and one or more non-driving portions.

In an embodiment, a vehicle comprising a driving portion and a non-driving portion can have one or more sensors in the driving portion and one or more sensors in the non-driving portion. In a further embodiment, a vehicle comprising a driving portion and a non-driving portion can have one or more sensor groups in the driving portion and one or more sensor groups in the non-driving portion. In a further embodiment, and without limitation, the rollover detection system is able to receive information not only from a group of sensors placed in the vehicle, but also form a group of sensors placed in a vehicle component which is not rigidly linked to the vehicle, including movable parts of the vehicle. These movable parts include, without limitation, an articulated arm of a bulldozer or an excavator. In this way, the rollover detection system is able to use different algorithms for different types of vehicles and setups in order to represent the position, movement and the dynamics of every component of the vehicle in order to calculate the vehicle stability and the risk of a rollover.

In an embodiment, a sensor or a group of sensors can provide a device with information that the device can use to determine whether a situation exists where a roll over can occur. In a vehicle where there is a driving portion and one or more non-driving portions, the sensors can provide a device information on which portion of the vehicle is at risk of rolling over and to which side a rollover may occur.

In an embodiment, and without limitation, in determining whether a rollover of a vehicle is possible, the rollover detection system analyzes several dynamic parameters by using one or more algorithms in order to calculate the stability of the vehicle at each moment of the vehicle use. In one embodiment, and without limitation, these parameters can include analysis of 3-axis accelerations and/or 3-axis angular rates. Other parameters that can be used are known to one of skill in the art.

In an embodiment, a device comprises multiple components and sensors, including, without limitation, an inclinometer, a combined GPS/GSM device, a central processing unit (CPU), a memory device, a means to notify a driver and a means to protect the driver in case a vehicle rolls over. An example of a device is described in PCT/ES2011/070646, which is incorporated herein. In an embodiment, an inclinometer provides information about the inclination of the vehicle. This inclination information can be provided in terms of the pitch and roll of the vehicle in relation to certain Cartesian axes parallel to the terrain on which the vehicle is located. In an embodiment, a device, in its GPS function, provides the data about the position of the vehicle on the terrain. For this purpose it provides latitude, longitude, and elevation coordinates. In an embodiment, a device. In its GSM-GPRS function acts as a TCP/IP client.

In another embodiment, a CPU is powered by a power supply that is capable of operating at any voltage, including, without limitation, 1 volt (v), 2v, 3v, 4v, 5v, 6v, 7v, 8v, 9v, 10v, 11v, 12v, 13v, 14v, 15v, 16v, 17v, 18v, 19v, 20v, 30v, 40v, 50v, 60v, 70v, 80v, 90v, 100v, 110v, 120v, 130v, 140v, 150v, 160v, 170v, 180v, 190v, 200v, 210v, 220v, 230v, 240v, 250v or more. In an embodiment, a CPU reads and processes the information from the GPS/GSM device at least once every 1 second, 2 seconds, 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds, 19 seconds, 20 seconds, or more.

In an embodiment, a driver is notified that the inclinometer data generated by a device in a vehicle being driven has exceeded a preprogrammed limit potentially putting the vehicle in a position where if the driver does not take corrective action, the vehicle will roll over. To notify the driver several methods may be implemented. In an embodiment, a driver is provided a warning by a warning system that includes, without limitation, an alarm that includes, but is not limited to, a siren, a buzzer, a flashing light, a display, a stimuli and/or a voice message.

In an embodiment, a siren or a buzzer can be provided at a constant level of volume. In a further embodiment, a siren or a buzzer can be provided wherein the volume can change. For instance, and without limitation, the volume can increase then decrease and/or decrease then increase and/or change randomly. The volume chosen can, without limitation, increase as the risk of rollover increases and decreases as the risk of rollover decreases. In an embodiment, a siren or a buzzer is set up so that a particular value of stability will always correspond to a particular frequency in how often a siren or buzzer sounds. Frequencies can, without limitation, be linear or stepped. The frequency of a buzzer or siren can also increase in or decrease over time. For instance, as the risk of rollover increases, the frequency a buzzer or siren sounds can increase. In another embodiment, as the risk of rollover decreases, the frequency a buzzer or siren sounds can decrease. In another embodiment, the tone, cadence, pitch and or other variables that impact a sound can be altered to match the likelihood of a rollover. For example, and without limitation, the tone, cadence and pitch can become louder and more severe as the likelihood of a rollover increases, while they can become quieter and less severe as the likelihood of a rollover decreases. They can also remain the same or change as a siren or buzzer is going off. For example, and without limitation, the volume of a siren or a buzzer can increase in tone as it becomes more likely that a vehicle will roll over. If the siren or buzzer has been activated, and as rollover becomes more imminent, the siren or buzzer can take on a sound that varies in pitch, cadence and tone that becomes more pronounced. In a further embodiment, and without limitation, when a parameter associated with a threat of a rollover is determined by the device, a slow, low volume beeping occurs wherein the beeping speeds up in cadence and the volume and tone increase as rollover becomes more imminent.

In an embodiment, a warning can be in the form of a light that is capable of flashing or providing some other means of conveying a warning. In an embodiment, a flashing light can be any color, including, without limitation, red, yellow, blue and/or, green or any other color or combination of colors. In an embodiment, a warning light flashes when a parameter associated with an increasing imminence of rollover is triggered to notify the driver of the potential for rollover. For instance, and without limitation, a light can flash slowly when the potential for a rollover is first determined, with the frequency of the flashing increasing as the potential for a rollover increases. Further, and without limitation, a flashing light may be of a constant or a different brightness. For instance, and without limitation, when the potential for a rollover is first determined by the device, the light may flash dimly. As the potential for a rollover as determined by the device increases, the brightness may increase, becoming brighter and brighter. In another embodiment, the flashing light may change colors as the imminence of a rollover increases. For example, and without limitation, when no rollover threat is determined by the device, the light may be green. When a rollover threat is first determined, the green light may change to yellow. When a rollover threat is imminent, the light may change to red. In this embodiment, after a driver takes a corrective action, the light can change from red back to yellow and then green to indicate that no parameter associated with a rollover by the device has been triggered.

In an embodiment, a warning can be in the form of a stimuli. For example, and without limitation, a driver may be stimulated in a manner by the seat that the driver is sitting. The seat, without limitation, can provide an electrical shock to the driver, with the intensity of the shock increasing as the imminence of a rollover increases. The shock can be of a voltage that causes increasing discomfort of a driver, without causing physical harm. In a further embodiment, a stimuli can be a change in the contour of the seat in which the driver is sitting. For instance, and without limitation, the seat can change shape, the seat can push against a driver with the strength of the pushing increasing as the imminence of a rollover increases and/or the seat can heat up or cool down with an increase in the imminence of a rollover. In another embodiment, protruberances can come out of the seat and impact into the driver, with the number of protruberances and/or their length increasing as the risk of a rollover increases and the number of protruberances and/or their length decreasing as the risk of rollover decreases.

In an embodiment, a warning can be provided by a display. For instance, and without limitation, the display shows the instability in a manner that alerts the driver so that the driver makes an intuitive counteraction that reduces or obviates the rollover risk that is to be avoided. In an embodiment, a display is designed following integration and ergonomic criteria. For example, and without limitation, the display is designed to provide information to the driver so that the driver response time is minimized when a certain level of instability is detected by the device. In a further embodiment, a display as depicted in FIG. 2, is formed by two horizontal countered light emitting diode (LED) bars that show the level of instability and the direction of said instability. In function, in this embodiment, this means that if the instability occurs in the left direction resulting from a device determining that there is a rollover risk to the left, the left LED bar will indicate the instability level to the driver and the imminence of the rollover. As shows in FIG. 2, as the risk of rollover grows, more LEDs are illuminated, starting from the center and lighting up in a leftward direction. In this embodiment, if the rollover risk is to the right, the LEDs that are located right of center will illuminate, starting with those closest to the center of the bar and moving towards the right, with each LED illuminated symbolizing an increasing risk of rollover as determined by the device.

In an embodiment, a display is designed to be adapted to a vehicle's interior. In a further embodiment a display is adapted to the vehicle's interior, including, without limitation, a dashboard so that it can meet ergonomics and safety standards regarding the placement of warning signals.

In an embodiment, a display is prepared by standard manufacturing methods used to prepare screens of this type. In a further embodiment, a display is prepared using 3-D printing that allows, without limitation, the display design to be adapted to the dashboard contours of any vehicle at a reasonable price.

In an embodiment, the LEDs can for instance, be one color or more than one color. In an embodiment, and without limitation, the LEDs closest to the center are green in color, those in the middle of the left side of the display and the middle of the right side of the display are yellow in color and those that are most leftward and most rightward are red in color. Like the flashing lights, the color of the light can be associated with the risk of rollover. In this instance, and without limitation, green can symbolize no rollover risk, yellow can symbolize a moderate rollover risk and red can symbolize a high rollover risk.

In another embodiment, a display can be a screen, for instance, and without limitation, an LED screen, a plasma screen, a television screen or any other form where data is displayed on a screen. The data provided to a driver in the screen can be, without limitation, in the form of words or a verbal warning, a diagram, a graph, or any other form capable of providing the driver with the information necessary to show the imminence of a rollover.

In an embodiment a display can be a single display, a dual display, a triple display or a display with four or more different screens. The display can be located in a housing, wherein the housing is comprised of a plastic, a metal, a ceramic, a carbon fiber or any combination thereof.

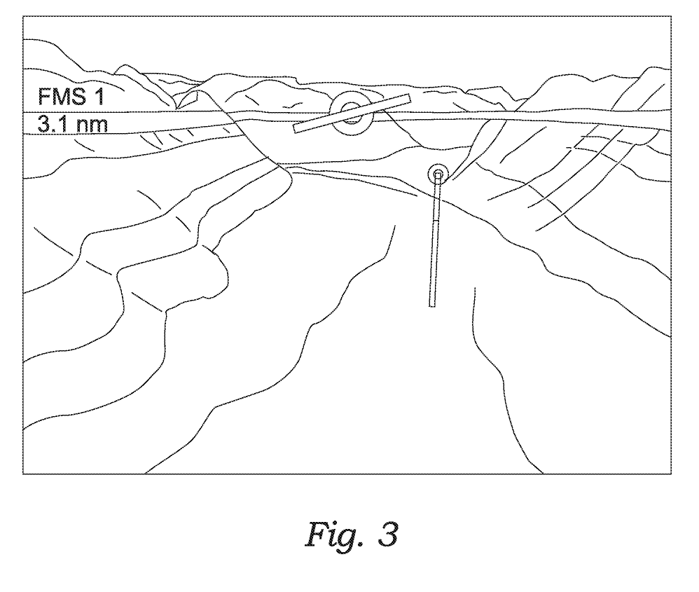

In a further embodiment, a display can provide a three dimensional topographical representation of the terrain in front of the driver and the vehicle wherein the representation is provided by the device using stored topographical and/or map data and GPS information. In this embodiment, the driver can be shown a three dimensional view of the topography of the terrain in front of the vehicle (FIG. 3). With this view, the driver can determine which direction of progress can result in the vehicle suffering from a risk of a rollover. For instance, and without limitation, the terrain may be color coded with green representing flat or nearly flat terrain, yellow representing terrain where the likelihood of a rollover is possible and red representing terrain where a rollover is likely. While green, yellow and red are provided as exemplary colors, any color system can be used as well as a grey scale. In another embodiment, the display can provide instructions to the driver identifying the path forward with the lowest chance for a rollover. This instruction can be provided, without limitation, by an arrow showing the direction the vehicle should be driven and/or a verbal instruction through a speaker in the vehicle on which way the driver should proceed as the vehicle moves forward.

In a further embodiment, one or more speakers can be located in a vehicle that can communicate with a driver. In this embodiment, as the risk of rollover is detected, a voice is provided that informs a driver that there is a risk of rollover of the vehicle if a course correction is not instituted. For instance, and without limitation, the voice can say “Rollover risk identified,” or “Risk of rollover, make course correction” or any other statement that conveys the risk to the driver and/or the corrective action the driver should take. Moreover, the voice can provide verbal instructions to the driver informing the driver of the course correction that the driver should take. In an embodiment, the volume of the voice is constant. In another embodiment, the volume of the voice increases as the risk of rollover increases and decreases as the risk decreases. In an embodiment, the cadence of the voice is constant. In a further embodiment, the cadence of the voice speeds up as the risk of rollover increases and slows down as the risk decreases.

In an embodiment, a device is connected to a wireless device that provides real time data regarding the risk of rollover of a vehicle to a third party. In a further embodiment, and without limitation, a wireless device can be a device that can connect to the internet, a blue tooth device or any device that can communicate with another device wirelessly. In an embodiment, and without limitation, a third party can be a person, a cell phone or a computer system, including, without limitation, a personal computer, a computer network, a cloud site, a tablet, a smartphone or a laptop. In this embodiment, when a rollover risk is detected, a signal or message is sent to the third party notifying them of the risk of rollover. In response, and without limitation, the third party can contact a driver to inform them of the rollover risk. Such contact can be by cell phone, by triggering a warning system, including, without limitation, providing a warning to the driver by voice through a one or more speakers located in the vehicle. In an embodiment, the instructions provided by a third party can warn the driver of a rollover and/or provide instructions on course corrections that are to be undertaken to prevent a rollover. In an embodiment, a driver can communicate with a third party who can respond to verbal statements, for instance, through a microphone located in the vehicle or through a cell phone, a walkie talkie or other two way communication device. In this embodiment, the driver and the third party can communicate in real time so that the driver can be instructed on how to avoid a rollover of the vehicle.

In an embodiment, the warning provided to a driver can be provided by more than one type of warning system. For instance, and without limitation, a vehicle may contain a display and an alarm, buzzer and/or verbal warning system. In this manner, a driver can be provided multiple warnings at once so that the driver registers at least one of the warnings and takes the corrective action necessary to avoid the rollover of the vehicle.

In an embodiment, where a vehicle has a driving portion and a non-driving portion, the rollover detection system can identify which portion of the vehicle is at risk for a rollover and provide the information to a driver through a warning system. In an embodiment, and without limitation, a driver can be notified through a display and at the same time receive a vocal warning. The rollover detection system can be set up, without limitation, to identify the specific portion of a vehicle that is at risk to a rollover and to which side. For example, and without limitation, a driver can receive a voice message informing the driver that a trailer attached to a truck is at risk of rolling over on its right side. This same voice message, without limitation, can provide instructions to the driver on how to avoid the rollover. Moreover, a display can, without limitation, provide information about each portion of a vehicle and provide a driver information about which portion of a vehicle will likely rollover if no course correction is taken and the imminence of such a roll over. Using this information, the driver can make appropriate course corrections to avoid the rollover.

In an embodiment, the system is connected to a remote user who is able to control the vehicle. In this embodiment, and without limitation, a vehicle can be an unmanned vehicle that a remote user is driving. In another embodiment, and without limitation, a remote user is monitoring a vehicle driven by a driver to ensure that the vehicle is operating within a predefined normal parameter, including, without limitation, parameters related to roll over risk. In this embodiment, and without limitation, if the rollover detection system determines that a risk of roll over exists, a driver may or may not be notified by a warning system and the rollover detection system will through a wireless device inform a remote user of a potential for a roll over. Once the remote user receives a warning of a potential roll over, in an embodiment, and without limitation, the remote user can contact the driver and inform the driver of the roll over risk. In another embodiment, and without limitation, the remote user can contact the driver and inform the driver of the corrective action to take to avoid a roll over risk. In a further embodiment, and without limitation, once a remote user is notified of a roll over risk, the remote user may take control of a vehicle remotely to allow the remote user to steer the vehicle in a manner to avoid a roll over. The rollover detection system can provide the remote user with the same or different information as a driver and the display or notification with a warning system available to the remote user can be the same or different than a driver.

In an embodiment, the information received by a driver and/or a remote user warning of a roll over can be provided in a form chosen by a remote user and/or a driver. For instance, if the information is provided on a display, a driver and/or a remote user can if the rollover detection system allows, without limitation, change the colors used to display the information; change the way the information is displayed or in certain circumstances, change the type of information displayed. In an embodiment, a driver and a remote user see the same information on a warning system. In another embodiment, a driver and a remote user see different information on a warning system.

In order to record and keep track of everything that the sensors measure and the algorithms calculate, the rollover detection system is equipped with an internal memory system, located, without limitation, in the device. In this way, everything is recorded for each calculation cycle, with a calculation cycle of 1 cycle/second, 2 cycles/second, 3 cycles/second, 4 cycles/second, 5 cycles/second, 6 cycles/second, 7 cycles/second, 8 cycles/second, 9 cycles/second, 10 cycles/second, 11 cycles/second, 12 cycles/second, 13 cycles/second, 14 cycles/second, 15 cycles/second, 16 cycles/second, 17 cycles/second, 18 cycles/second, 1 cycles/second, 20 cycles/second, or more. In an embodiment, the information is recorded in a register file or several register files (for example, one file per day) and it can be encrypted if necessary. In this manner, the saved information stored in the register file or several register files can be downloaded from the device and processed and analyzed externally.

In an embodiment, a device has a memory. The memory, without limitation, can be a hard driver, a flash drive, a removable hard drive, a removable flash drive, an SD card, a miniSD card, a zip drive, a floppy drive and/or a external hard drive that is connected to the a device. The memory can be, without limitation, primary memory such as, random access memory (RAM). The memory can be, without limitation, secondary memory. The information collected by a device can be stored in the memory of a device. The memory can include information obtained from a sensor or a group of sensors. The information stored in the memory can be taken in and analyzed by the device to determine the risk of a rollover every 0.1 second, 0.2 second, 0.3 second, 0.4 second, 0.5 second, 0.6 second, 0.7 second, 0.8 second, 0.9 second, 1 second, 1.1 seconds, 1.2 seconds, 1.3 seconds, 1.4 seconds, 1.5 seconds, 1.6 seconds, 1.7 seconds, 1.8 seconds, 1.9 seconds, 2 seconds, 2.1 seconds, 2.2 seconds, 2.3 seconds, 2.4 seconds, 2.5 seconds, 2.6 seconds, 2.7 seconds, 2.8 seconds, 2.9 seconds, 3 seconds, 3.1 seconds, 3.2 seconds, 3.3 seconds, 3.4 seconds, 3.5 seconds, 3.6 seconds, 3.7 seconds, 3.8 seconds, 3.9 seconds, 4 seconds, 4.5 seconds, 5 seconds, 5.5 seconds, 6 seconds, 6.5 seconds, 7 seconds, 7.5 seconds, 8 seconds, 8.5 seconds, 9 seconds, 9.5 seconds, 10 seconds, or more.

In an embodiment, the rollover detection system uses information comprising static and dynamic properties of the vehicle in order to calculate vehicle stability and the imminence of a roll over. This information is stored in the rollover detection system memory in such a way that it can be used by the device algorithms used for the stability calculations to determine roll over risk. In an embodiment the information that is stored in the rollover detection system memory can be accessed by a driver, a remote user or other party. In this manner, the driver, remote user or other party can use the information stored in the memory to review the sensor data of a vehicle prior to and during a rollover to determine what caused the rollover; to teach the driver involved in a rollover or other driver or remote user how to avoid a rollover in the future.

In an embodiment, the rollover detection system is able to receive a signal from several components of the vehicle and store their status or value in the register file at each calculation cycle. These components include, but are not limited to, the an accelerator pedal position, a braking pedal position, a braking system pressure value, a speedometer value, a RPM value, a steering wheel angle, and/or a GPS.

In an embodiment, these signals can be captured either from the vehicle control unit or from individual sensors placed at each component and connected to the rollover detection system. In another embodiment, these signals can be used by the algorithms run by the device to determine the rollover risk of a vehicle.

In an embodiment, and in order to better track and evaluate a driver's reaction to the circumstances that they are exposed to during the operation of a vehicle, the rollover detection system can include a video capture system. In an embodiment, and without limitation, the video capture system can be installed in a vehicle cabin in a location that is able to record one, two, three, four, five, six, seven or more views of a driver. For instance, and without limitation, a video capture system can include a view where the driver is facing the outside of the cabin, which also allows the video capture system to record the vehicle's track and a second view facing the inside of the cabin and recording the driver and their reactions during the operation of the vehicle. In another embodiment, the video capture system can also capture views on either side of a vehicle or behind the vehicle. The video capture system can include, without limitation, a camera that is stationary and/or is able to move during operation. The video capture system can also include, without limitation, a camera that has a panoramic view, a narrow focus or a view that changes as the vehicle is driven.

In an embodiment, the generated video files can be, for instance, and without limitation, stored in the rollover detection system memory. This allows for the video files to be synchronized with the data record and storage in order to process and analyze both the recorded data and video at the same time. In another embodiment, the generated video files can be, for instance, without limitation, uploaded through a wireless or blue tooth connection to a remote storage device, including, without limitation, a server, a cloud site or a computer.

The video files can be reviewed at a later time to determine the actions a driver undertook during a period where a rollover risk was present. The video files can be used, for instance, and without limitation, to identify any actual or potential mistakes made by the driver that resulted in a risk of a rollover or an actual rollover; to educate the driver and/or the remote user of the vehicle so that a mistake made that resulted in a risk of a rollover or an actual rollover can potentially be avoided in the future; and/or to train another driver so that a mistake made that resulted in a risk of a rollover or an actual rollover can potentially be avoided in the future.

In an embodiment, the video capture system is streamed over a wireless connection or Bluetooth connect to a remote site where a remote user is able to monitor the driver in real time. Through this video capture system, the remote user can determine in real time if the driver is impaired, sleepy or suffering some other issue that would impact the driver's ability to avoid and/or respond to a rollover risk identified by the rollover detection system. In another embodiment, and without limitation, the video capture system allows a remote user to determine in real time if the reactions to a rollover risk by a driver are appropriate and where necessary, allow the remote user to intervene when a rollover risk is determined or rollover is imminent. During an intervention, the remote user can, without limitation, contact the driver vocally through a speaker in the vehicle, by text through a display or through other stimuli so as to notify the driver of a risk of rollover so that the driver takes corrective action. Another form of intervention can include, without limitation, the remote user taking over control of the vehicle remotely and taking corrective steps to mitigate a risk of rollover or prevent a rollover.

In an embodiment, the rollover detection system can take advantage of the fact that a risk assessment has been performed and, even if the driver is warned with enough of a margin to take the proper actions to avoid a rollover, the rollover detection system can trigger several non-driver or remote user protection actions in case a rollover event is detected. These actions have work to protect the vehicle and/or a driver and any passenger in case of rollover.

In an embodiment, the rollover detection system includes an Automatically Deploying Rollover Protective Structure (AutoROPS), which stays in a lowered position until a rollover condition is determined, at which time it deploys to a fully extended and locked position. AutoROPS refers to operator compartment structures (usually cabs or frames) that protect equipment operators, such as a driver and/or a passenger from injuries caused by vehicle overturns or rollovers. In an embodiment an AutoROPS is added or included with a vehicle and the AutoROPS is linked to the rollover detection system in a manner wherein if the device determines that a roll over is imminent, the AutoROPS is activated and deployed to protect the vehicle and driver and/or passenger from harm. In an embodiment, the AutoROPS is linked to equipment that provides for the rapid expansion and deployment of the AutoROPS when a roll over is determined by the rollover detection system to be imminent. Deployment can occur by equipment that uses, without limitation, a spring, a gas, a fluid or a controlled explosive charge that when activated results in the AutoROPS being fully extended and locked in place to protect a driver and/or a passenger and/or a vehicle during a roll over. In an embodiment, an AutoROPS is constructed of a material that during a roll over will protect the vehicle and a driver and/or passenger. The material can be, without limitation, metal, ceramic, plastic and/or carbon fiber. If the material is a metal, it can include, without limitation, steel, aluminum, magnesium, titanium, zinc, copper, brass and/or any combination of them. A carbon fiber includes, without limitation, carbon-fiber-reinforced polymer, carbon-fiber-reinforced plastic or carbon-fiber reinforced thermoplastic. A ceramic includes, without limitation, a technical ceramic. In another embodiment, without limitation, a ceramic is a composite or a crystalline ceramic. The material can be, without limitation, a ceramic or carbon fiber. In a further embodiment, a metal, ceramic, plastic and/or carbon fiber can be covered with another material, including, without limitation, a rubber, a plastic, a metal, a ceramic and/or a carbon fiber.

In an embodiment, an AutoROPS can, without limitation, be used to protect certain components and parts of a vehicle that are susceptible damage due to a rollover. These parts can, without limitation, be expensive to replace, difficult to be substituted, leak a hazardous material if punctured and/or result in a dangerous situation for the driver and/or a passenger if left unprotected. For example, and without limitation, military vehicles have several quite expensive components, such as the shooting tower and the auto-aiming laser system on the roof of a tank or other military vehicle and the communications and GPS system that can be located on the outer surface of a military vehicle. During a rollover, it is not uncommon that these components are the first ones that are damaged when a military vehicle overturns, and protecting these items would provide for a large saving to the military for repairs and substitution costs.

In an embodiment, for vehicles that comprise multiple movable components with relative movement, including, without limitation, bulldozers, excavators, tanks, dump trucks and other vehicles with movable components, the rollover detection system can utilize the movable components to affect the overall stability of the vehicle after taking into account the position and dynamics of every movable component. During operation, the movable components are controlled by the vehicle's control unit, which receives the move order from a driver and/or a remote user and moves according to a drivers and/or remote user's input. The rollover detection system, which is continually monitoring the overall stability of the vehicle, can when a risk of rollover is determined, disconnect the control unit from the movable components, allowing the rollover detection system to interact with the movable components and utilize them to prevent or minimize the damage from a rollover. This interaction occurs by, without limitation, triggering certain predefined movements by the movable components based on the data received related to a specific rollover event and/or having the rollover detection system move the movable components at the time when a risk of rollover is determined or when a rollover is imminent in a manner determined by the system at that time to reduce the possibility of a rollover and/or prevent a rollover. In a different embodiment, the rollover detection system can disconnect the control unit when a roll over is imminent so that the rollover detection system is able to interact with the movable components and utilize them to prevent or minimize the damage to a vehicle that occurs from a rollover.

In an embodiment, actions by the rollover detection system using movable components to prevent a rollover can include, without limitation, the automatic lifting or folding of the rear implement of a tractor; the automatic turning of the shooting tower of a tank or other vehicle, such as a Bradley troop transport, in the opposite direction of the rollover; and the proper movement of the body and the movable arm of an excavator. In each instance, the action by the rollover detection system would minimize the damage to the vehicle in case of rollover. Further, by moving the movable component away from the direction of a rollover, the weight of the vehicle is shifted away from the direction of a rollover, which can result in a reduction in the likelihood of the rollover.

In an embodiment, the rollover detection system can be used to train a driver and/or a remote user. In this embodiment, the rollover detection system can be used, for instance, and without limitation, in a simulator where situations are created that if not corrected would result in a rollover. The training can also occur, for example, and without limitation, in a vehicle set up specifically for training a driver and/or remote user. The system can be attached to a simulator, for example, without limitation, a flight like simulator, a computer station or other simulator. In an embodiment, a simulator is set up to mimic the movement of a vehicle over off-road terrain. In this embodiment, the simulator depicts the movement of a vehicle over terrain and when the rollover detection system determines that the movement has resulted in a rollover risk, a warning system provides a driver and/or a remote user with a warning and if available, the means to correct the course of the vehicle so no roll over occurs.

In a further embodiment, training can occur in an area set up specifically to be used by a training vehicle. The area can include different terrain features that allow a driver and/or remote user the ability to respond to a roll over risk created by the different terrain in the training area. The training vehicle can be set up such that an instructor is able to take over the vehicle if a driver and/or remote user has taken actions that result in a rollover risk. In this manner, the instructor is able to intervene to prevent a roll over, for instance, if a rollover is imminent if the instructor does not intervene. The instructor can intervene by being in the training vehicle and having access to a means to control the vehicle or by having remote access to the vehicle. This can include, without limitation, the instructor having their own steering wheel and gas and brake pedals.

By providing training with the rollover detection system in a simulator, a driver and/or remote user becomes more aware of, and how to respond to, a rollover detection system and the warning system that provides the information related to the risk of a rollover. In this manner, when a driver and/remote user are in a vehicle and are traversing terrain, such as off-road, they will have gained the experience that is necessary to respond to a situation where a rollover risk is determined by the rollover detection system.

The rollover detection system can also include a driver identification system to ensure that the driver who will operate the vehicle is the one who is supposed to operate the vehicle. Such a driver identification system could prevent the misuse of a vehicle and/or the vehicle's theft. The driver identification system can use, without limitation, one or more of the following parameters: a fingerprints sensor, a FID card identification system, a facial image recognition (using the cabin video capture) or any other system that can identify the individual driver.

In an embodiment, the rollover detection system includes software that is able to analyze all the information recorded by the rollover detection system during the operation of the vehicle and/or the training of a driver and/or end user. This software can be installed, without limitation, in a computer, a tablet, a smartphone, a server and/or on a cloud site, all of which can receive the register files downloaded from the system, as well the video files recorded. Receipt of the register files and/or video files can be through a wireless transfer, with the wireless transfer occurring at or around the time the information is received and/or at a later time. In another embodiment, the register files and/or video files are transferred from a memory in a device of a rollover detection system using an external memory, including, without limitation, an external hard drive, a memory stick (also referred to as a thumb drive), an SD card, a miniSD card, a Zip drive or other memory medium.

In an embodiment, a register file and/or a video file is encrypted by a device of a rollover detection system and decrypted when accessed on a computer, a tablet, a smart phone, a server and/or a cloud site. Once decrypted, a register file and/or a video file is stored in a computer, a tablet, a smartphone, a server and/or a cloud site. In an embodiment, and without limitation, a register file and/or a video file is stored following a folder distribution according to certain pre-defined criteria ( . . . /drivers name/date, for example).

After the information is decrypted (if necessary) and downloaded, the software is used to analyze and provide a means and method for an individual to access the information regarding a selected register file (corresponding to a rollover detection system record) on a screen in such a way that it can be analyzed in an intuitive manner by the individual viewing the information. The software itself, can, without limitation, provide an individual with multiple options on what information is accessed and how that information is analyzed and displayed.

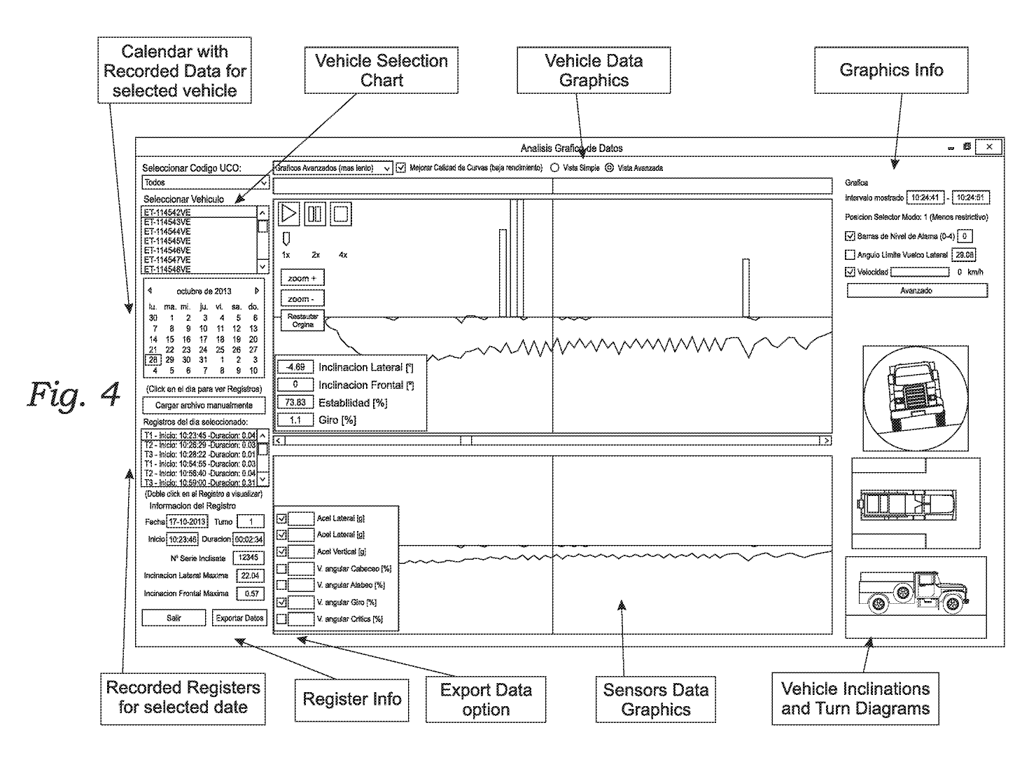

FIG. 4 depicts for representative purposes only, a screen shot of the information in a register file when viewed on a display using the software that is able to provide and/or analyze the information in a register file. For instance, as depicted on the right side of the screen shot, the information displayed can include, but is not limited to, information related to the inclination of a vehicle during the time this vehicle was driven. The inclination information, which is presented with a pictorial representation of a vehicle, can be shown from different angles and during viewing, the information can be stopped, forwarded, including fast forwarded and/or reversed, including fast reverse. The screen shot can also show, but is not limited to, a representation of the information in a register file in a graphical form, for instance, and without limitation, the lateral and frontal inclination of the vehicle during the time the vehicle was driven. Similar to the portion of the screen shot that shows a pictorial representation of a vehicle, the individual viewing the information on the screen can stop, forward, including fast forward and/or reverse, including fast reverse. The software that is used to analyze the information stored in a register file can display other information and the analysis of other information stored in a register file.

In an embodiment, the software provides the user with the ability to analyze all the data received from the rollover detection system in order to identify risk situations that could have been prevented. For example, and without limitation, the software allows for the analysis of the information collected by a sensor or a group of sensors on and/or in a vehicle after a rollover has occurred so that it can be determined what factors resulted in the rollover. For instance, since the vehicle sensor and/or other parameter information is recorded by the rollover detection system, including, without limitation, acceleration, brake pedal position, steering wheel position, GPS, inclination and/or speed, the software allows for a better understanding of what occurred that led to a rollover just before the rollover event.

In an embodiment, the rollover detection system is equipped with a data transmission system. This system can be, for example a GPRS/GSM system, a RFID system, a RF system, a wireless system, or a Bluetooth system

In an embodiment, a GPS system and a data transmission system allow for a driver, a remote user or other individual: to know the position of the vehicle during the operation of the vehicle; to be able to use the software to plot the location of the vehicle during the period of operation; and/or to send an alert or message using a data transmission system with the GPS position of the vehicle, as well as some other relevant information (cabin view, for example) in case of a rollover. In this embodiment, the alert will help to minimize the response time of safety, health and/or sanitary services in case of a rollover.

In an embodiment, the receiver of an alert can be, without limitation, an online platform installed in a web server and accessible from a web site. In another embodiment, the receiver of an alert can be, without limitation, a cloud site, a phone number, a smartphone, a computer and/or a tablet. Upon receipt of an alert, the information can be transmitted to an individual so that a response by safety, health and/or sanitary services can occur. By using such a system, it may be possible to mitigate the harm suffered by a driver and/or passenger.

In another embodiment, the rollover detection system includes an application that is loadable on a smartphone. In an embodiment, and without limitation, a smartphone is an iphone, an android phone, a Windows phone and/or a Blackberry®. In an embodiment, and without limitation, the application can receive real time data and information from the rollover detection system informing the smartphone owner of the status of a vehicle in which the rollover detection system is operating. The application can include, without limitation: a depiction of the current location of the vehicle; a depiction of the risk of rollover of the vehicle, for instance, and without limitation, in a display similar to that of FIG. 4; a live feed of video recording the driver and the vehicle; charts, figures, graphs, pictures and other depictions of the various parameters used to determine a rollover risk by the system; and a means to contact the driver and/or remote user in the case of a rollover risk is determined or a rollover is considered imminent.

In an embodiment, a smartphone can view the analysis provided by the software. In this embodiment, the smartphone allows its user to, without limitation, examine the cause of a rollover.

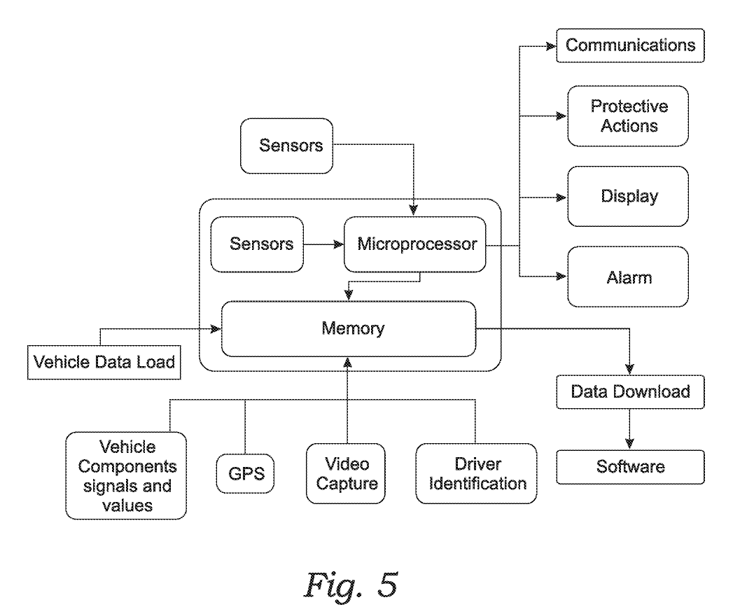

FIG. 5 depicts the rollover detection system. The rollover detection system is shown to include several inputs that provide information that is used to track the vehicle and provide the state of the vehicle during the time it is driven. The rollover detection system includes a GPS, a video capture system, a driver identification system, a vehicle data load and other vehicle components, signals and inputs. In an embodiment, the information collected from the vehicle sensors and other parameters is stored in a memory. As depicted, the rollover detection systems includes one or more sensors or sensor groups that report the information collected to a microprocessor or central processing unit (“CPU”). The information is put through one or more algorithms that determine if the vehicle faces a rollover risk. The results of the calculation by the one or more algorithms is stored in the memory and outputted to the driver in the form of a warning system, activation of protective actions and if the rollover detection system is connected by wireless or Bluetooth, the results are transmitted to a computer, a tablet, a server, a cloud site or a smart phone. Further as depicted in FIG. 5, the information stored in the memory can be downloaded to another device or an external memory storage device, such as a SDcard, miniSDcard, an external hard drive, a Zip drive or a memory stick.

In order to train individuals who will be working with a vehicle that may be subject to a situation that could result in a rollover, a simulator is created to provide the individual with experiences that are similar to those that the individual may experience in the real world using the rollover detection system. To make this work, the system is written to provide instances of a potential rollover along with the response that would occur as a result of the rollover detection system providing information regarding the potential rollover to the individual.

To accomplish this task, an algorithm has been created that has input functions and data that process the inputs in order to calculate a value of stability and inclination as a function of said inputs, and then gives several outputs from the system to the individual. The algorithm can be a new one or one that is adapted from the algorithm used in the device as previously described to determine the inclination and/or stability of the vehicle. The form of the outputs can be, but are not limited to, mathematical functions representing the value of the alarm frequency, the level of the display related to the potential likelihood of a rollover and/or a function representing the value of the stability, or other function.

The algorithm itself is used to simulate the behavior of the rollover detection system that is in an actual vehicle. This is accomplished by having the simulated rollover detection system utilize several types of artificial input functions, which represent every described input of the system in the vehicle, including, but not limited to: sensor data, switch positions, vehicle speed, and other data and information that is and can be collected. Additional inputs can also be used, including, without limitation, data corresponding to the vehicle parameters, as well as the input parameters in order to make the algorithm be set up correctly (alarm levels, input filters, etc).

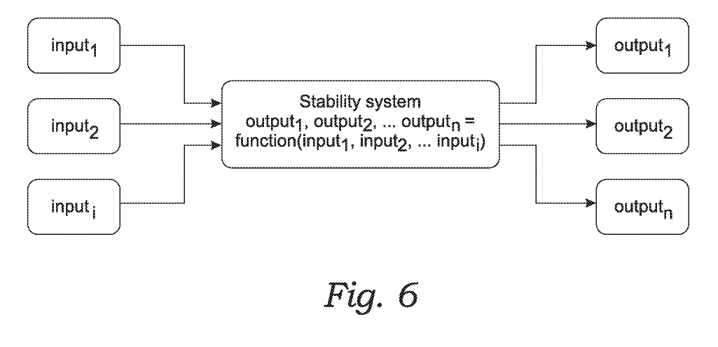

Internally, the main rollover detection system function can conducted using a group of functions (sequence functions, nested functions) that analyze all the data and perform all the functionalities of the rollover detection system (FIG. 6). Through all of this, the simulator is set up to provide real world experiences with a rollover detection system to a user without having to take a vehicle that has the device installed out into the real world and risk an actual rollover during training.

A rollover detection system can be connected and integrated with a GPS system for turn detection and warning. This system works by having the GPS send data of an upcoming turn that the vehicle is going to experience (when a route that is being driven is one that has been created through the use of GPS), and the rollover detection system will analyze the received data along with the system information provided by the sensors of the device (including, without limitation, vehicle speed, steering wheel position, etc.) and warn the driver in advance if the vehicle speed must be lowered in order to ensure that the vehicle will not face a potential rollover as the vehicle enters the turn. This can be through an alarm, a display or a flashing light.

In an embodiment, a rollover detection system is utilized with an emergency vehicle through which the rollover detection system actuates through the vehicle's ECU (electronic Central Unit) in order to control the vehicle parameters and behavior based on stability criteria, in order to avoid rollover. In a further embodiment, an emergency vehicle is a police vehicle, a fire truck, an ambulance or other vehicle.

In an embodiment, a sensor is located in a part of a vehicle that contains a material, for instance, without limitation, a liquid that may move during the motion of the vehicle. The sensor is able to detect the motion of the material and provide information and data to the CPU of the device, including, but not limited to changes in the center of gravity of the liquid in the vehicle for use in analyzing the probability of a vehicle to rollover. In an embodiment, a liquid can be the water in a tank of a fire truck or a liquid in a trailer tank for the storage of a fluid.

In another embodiment, a rollover detection system is used in a train. In this embodiment, the rollover detection system is linked to sensors in the engine and in one or more train cars to detect the potential for a rollover. As the train is being operated, the sensors provide the CPU in the device with information and data regarding the stability of the engine and one or more train cars and with this information and data, determine the likelihood of a potential rollover. If a rollover is possible, the device provides information to an individual driving the train informing the individual that the engine or one or more cars are at risk of a potential rollover and allowing the driver to take actions to prevent a rollover.

The system is able to recalculate the center of gravity of both this component and the entire vehicle at each moment depending on this liquid level. The liquid level influences the stability of the vehicle in several ways, including, but not limited to the: (1) Changes in the weight and center of gravity of the liquid during operation of the vehicle that can result in a change in the vehicle weight distribution and inertia; and (2) Instability due to sloshing effects of the liquid during the operation of the vehicle. In this instance, if the sloshing natural frequencies of the liquid inside the tank are reached (due to vibrations, braking, etc.) the vehicle can be subjected to high lateral forces and inertias, which can lead to rollover. While it is not uncommon for tanks containing a liquid being prepared to minimize this effect, the rollover detection system can be prepared to detect vibration frequencies and warn the driver if they get close to a sloshing natural frequency that can increase the likelihood of a rollover.

In an embodiment, a rollover detection system is installed in a small power driven gardening or recreational vehicle. These vehicles can include, without limitation, a golf cart, a riding lawn mower, a powered walking lawn mower, a powered garden hoe or other small power driven vehicle. In another embodiment, the rollover detection system for a small power driven gardening or recreation vehicle would include the minimum system requirements necessary to make the system work properly, since such a rollover detection system requires only a few sensors and can use a simple warning system, for instance, without limitation, an alarm, a flashing light or a display.

In an embodiment, a rollover detection system reduces the likelihood of a rollover by at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95% as compared to a vehicle driven without the rollover detection system to detect a potential rollover. In another embodiment, a rollover detection system reduces the likelihood of a rollover by, e.g., about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70% as compared to a vehicle driven without the rollover detection system to detect a potential rollover.

In an embodiment, a rollover detection system increases the likelihood that a driver and/or a remote user is able to avoid a rollover by at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95% as compared to a vehicle driven without the rollover detection system to detect a potential rollover. In another embodiment, a rollover detection system increases the likelihood that a driver and/or a remote user is able to avoid a rollover by, e.g., about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70% as compared to a vehicle driven without the rollover detection system to detect a potential rollover.

In an embodiment, a rollover detection system reduces the cost of operating a vehicle by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 30%, at least %, at least 40%, at least 45%, at least 50%, at least 55%, at least 60%, at least 65%, at least 70%, at least 75%, at least 80%, at least 85%, at least 90%, at least 95% or more.

Aspects of the present specification may also be described as follows:
1. A rollover detection system for the dynamic monitoring of the stability of a vehicle, which system comprises: a device; a sensor or a group of sensors; and a warning system.
2. The rollover detection system according to embodiment 1, wherein the vehicle is one used in agriculture, military and forestry.
3. The rollover detection system according to embodiment 1 or embodiment 2, wherein the rollover detection relies on an analysis of dynamic stability.
4. The rollover detection system according to any one of embodiments 1-3, wherein the rollover detection system also relies on inclination.
5. The rollover detection system according to any one of embodiments 1-4, wherein a sensor or a group of sensors receive GPS data and/or topography data.
6. The rollover detection system according to any one of embodiments 1-5, wherein a vehicle contains one, contains two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more sensors.
7. The rollover detection system according to any one of embodiments 1-6, wherein a vehicle contains one, two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more groups of sensors.
8. The rollover detection system according to any one of embodiments 1-7, wherein a sensor or a group of sensors are located in one, two, three, four, five, six seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more locations in or on the vehicle.
9. The rollover detection system according to any one of embodiments 1-8, wherein a sensor is a radar, a GPS antenna and a GPS system, a camera or a CCD.
10. The rollover detection system according to any one of embodiments 1-9, wherein a sensor provides information and/or data to a device for use in calculating a rollover risk.
11. The rollover detection system according to embodiment 10, wherein the information and/or data comprises static and dynamic properties of the vehicle in order to calculate vehicle stability and the imminence of a roll over.
12. The rollover detection system according to any one of embodiments 1-11, wherein a vehicle has one, two, three, four, five or more different types of sensors.
13. The rollover detection system according to any one of embodiments 1-12, wherein a driver selects which sensor data is used to calculate a rollover risk.
14. The rollover detection system according to any one of embodiments 1-13, wherein a vehicle can have a driving portion or a driving portion and a non-driving portion.
15. The rollover detection system according to any one of embodiments 1-14, wherein a vehicle has a moving part.
16. The moving part according to embodiment 15, wherein the moving part is an articulated arm.
17. The articulated arm according to embodiment 16, wherein the articulated arm is the moving portion of a tractor, bulldozer or an excavator.
18. The rollover detection system according to any one of embodiments 1-17, wherein the calculation of the stability of the vehicle is based on an analysis of 3-axis accelerations and/or 3-axis angular rates.
19. The rollover detection system according to any one of embodiments 1-18, wherein the device comprises multiple components.
20. The rollover detection system according to embodiment 19, wherein the multiple components comprise an inclinometer, a combined GPS/GSM device, a central processing unit, a memory device and a means to notify a driver.
21. The rollover detection system according to any one of embodiments 1-20, wherein the device includes a means to protect the drive in case a vehicle rolls over.
22. The rollover detection system according to any one of embodiments 1-21, wherein a warning system comprises an alarm.
23. The rollover detection system according to embodiment 22, wherein an alarm comprises a siren, a buzzer, a flashing light, a display, a stimuli and/or a voice message.
24. The rollover detection system according to embodiment 23, wherein a volume of the siren or buzzer can remain constant, increase or decrease.
25. The rollover detection system according to embodiment 24, wherein the volume of the siren or buzzer increases with the increasing risk of a rollover.
26. The rollover detection system according to embodiment 24 or embodiment 25, wherein the volume of the siren or buzzer decreases with the decreasing risk of a rollover.
27. The rollover detection system according to embodiments 21-26, wherein the tone, cadence and/or pitch of the alarm can be altered to provide a driver notification of a risk of a rollover.
28. The rollover detection system according to embodiment 27, wherein the tone, cadence and pitch can become louder and more severe as the likelihood of a rollover increases.
29. The rollover detection system according to embodiment 27 or embodiment 28, wherein tone, cadence, and pitch can become quieter and less severe as the likelihood of a rollover decreases.
30. The rollover detection system according to any one of embodiments 23-29, wherein the flashing light includes one of more colors.
31. The rollover detection system according to embodiment 30, wherein the one or more colors includes red, yellow, blue, green and/or any combination thereof.
32. The rollover detection system according to any one of embodiments 23-31, wherein the flashing light flashes with an increasing frequency as the imminence of a risk of rollover increases.
33. The rollover detection system according to any one of embodiments 23-32, wherein the flashing light flashes with a decreasing frequency as the imminence of a risk of rollover decreases.
34. The rollover detection system according to any one of embodiments 23-33, wherein the flashing light brightens with an increasing risk of a rollover.
35. The rollover detection system according to any one of embodiments 23-34, wherein the flashing light dims with a decreasing risk of a rollover.
36. The rollover detection system according to any one of embodiments 23-25, wherein the flashing light changes colors with an increasing or decreasing risk of rollover.
37. The rollover detection system according to embodiment 36, wherein the flashing light changes from green to yellow to red as the risk of a rollover increases.
38. The rollover detection system according to any one of embodiments 23-37, wherein the stimuli is provided to a driver in the seat that the driver resides.
39. The rollover detection system of embodiment 38, wherein, the stimuli provided by a seat to a driver is a shock.
40. The rollover detection system according to embodiment 39, wherein the shock is an electrical shock.
41. The rollover detection system according to any one of embodiments 23-40, wherein the stimuli provided by a seat to a driver is a change in the contour of a seat or the temperature of a seat.
42. The rollover detection system according to embodiment 41, wherein the change in the contour is a protuberance extending from a seat.
43. The rollover detection system according to embodiment 42, wherein the protuberance increases in length as the risk of a rollover increases and/or decreases as a risk of rollover decreases.
44. The rollover detection system according to any one of embodiments 23-43, wherein the display comprises a two horizontal countered light bar.
45. The rollover detection system according to embodiment 44, wherein the two horizontal countered light bar comprises light emitting diodes.
46. The rollover detection system according to embodiment 44 or embodiment 45, wherein the lights on the left side of the two horizontal countered light bar light up when a risk of rollover to the left side occurs.
47. The rollover detection system according to any one of embodiments 44-46, wherein the lights on the right side of the two horizontal countered light bar lights up when a risk of rollover to the right side occurs.
48. The rollover detection system according to any one of embodiments 44-47, wherein the two horizontal countered light bar comprises green, yellow and/or red lights.
49. The rollover detection system according to any one of embodiments 44-48, wherein the first lights that are lit are green and as the risk of rollover increases the yellow lights are lit and as the risk of rollover becomes imminent, the red lights are lit.
50. The rollover detection system according to any one of embodiments 23-49, wherein the display can provide a verbal warning, a graph or a diagram.
51. The rollover detection system according to any one of embodiments 23-50, wherein the display can provide a three dimensional topographical representation of the terrain in front of the vehicle.
52. The rollover detection system according to any one of embodiments 23-51, wherein the display can provide a three dimensional topographical representation of the terrain to one or both sides and/or the back of the vehicle.
53. The rollover detection system according to embodiment 51 or embodiment 51, wherein the topographical representation of the terrain is provided in one or more colors.
54. The rollover detection system according to embodiment 52 wherein the colors are red, green, brown, yellow, blue or any combination thereof.
55. The rollover detection system according to any one of embodiments 23-54, wherein the voice message comprises a volume, a tone, a cadence, a frequency, or any combination thereof.
56. The rollover detection system according to embodiment 55, wherein the volume, the tone, the cadence and/or the frequency of the voice message increases with an increasing risk of rollover.
57. The rollover detection system according to embodiment 55 or embodiment 56, wherein the volume, the tone, the cadence and/or the frequency of the voice message decreases with a decreasing risk of rollover.
58. The rollover detection system according to any one of embodiments 23-57, wherein the voice message provided by the warning system is preprogrammed.
59. The rollover detection system according to any one of embodiments 1-58, wherein the device includes a means to provide information and/or data to a third party device.
60. The rollover detection system according to embodiment 59, wherein the information and/or data is provided to a driver, a third party user or other third party.
61. The rollover detection system according to embodiment 59 or embodiment 60, wherein the means to send information is through a wireless device and/or a blue tooth device.
62. The rollover detection system according to any one of embodiments 59-61, wherein the third party device is a cell phone, a computer system, a personal computer, a computer network, a cloud site, a tablet, a smartphone or a laptop.
63. The rollover detection system according to any one of embodiments 59-62, wherein the information sent to a third party device is viewed by a third party user.
64. The rollover detection system according to any one of embodiments 59-63, wherein the third party user is able to communicate with a driver when a rollover risk is detected.
65. The rollover detection system according to any one of embodiments 59-64, wherein the third party user provides information to a driver to take corrective action.
66. The rollover detection system according to any one of embodiments 59-65, wherein the third party user is able to remotely take control of a vehicle.
67. The rollover detection system according to any one of embodiments 59-66, wherein the third party is able to take corrective action to prevent a rollover.
68. The rollover detection system according to any one of embodiments 59-67, wherein the information and/or data is used to train a driver or third party how to avoid rolling a vehicle over.
69. The rollover detection system according to any one of embodiments 59-68, wherein the information and/or data is used to train a driver or third party to take the appropriate corrective action to avoid a rollover.
70. The rollover detection system according to any one of embodiments 59-69, wherein the training takes place in a simulator or a training vehicle.
71. The rollover detection system according to any one of embodiments 59-70, wherein the information and/or data is analyzed by software and the results provided to a driver, a third party user or other third party.
72. The rollover detection system according to any one of embodiments 1-71, wherein the device has a memory to store data and information to a driver or a third party user.
73. The rollover detection system of embodiment 72, wherein a third party can copy the data and information stored in the memory to an external memory device.
74. The external memory device of embodiment 72 or embodiment 73, wherein the device memory includes a flash drive, a removable hard drive, a removable flash drive, an SD card, a miniSD card, a zip drive, a floppy drive and/or an external hard drive.
75. The rollover detection system according to any one of embodiments 1-74, wherein the rollover detection system is able to receive a signal from one or more components of the vehicle and store their status or value in the register file at each calculation cycle.
76. The rollover detection system according to embodiment 75, wherein the one or more components include an accelerator pedal position, a braking pedal position, a braking system pressure value, a speedometer value, an RPM value, a steering wheel angle, a GPS and an inclinometer.
77. The rollover detection system according to any one of embodiments 1-76, wherein the system includes a video capture system.
78. The rollover detection system according to embodiment 77, wherein the video capture system is able to record one, two, three, four, five, six, seven or more views of a driver.
79. The rollover detection system according to embodiment 77 or embodiment 78, wherein the video capture system includes a view where the driver is facing the outside of the cabin to allow the system to record the vehicle's track.
80. The rollover detection system according to any one of embodiments 77-79, wherein the video capture system includes a view facing the inside of the cabin and recording the driver and their reactions during the operation of the vehicle.
81. The rollover detection system according to any one of embodiments 77-80, wherein the video capture system captures views on either side of a vehicle or behind the vehicle.
82. The rollover detection system according to any one of embodiments 77-81, wherein the video capture system comprises a camera that is stationary.
83. The rollover detection system according to any one of embodiments 77-82, wherein the video capture system comprises a camera that is able to move during operation.
84. The rollover detection system according to embodiment 83, wherein the camera provides a panaromic view, a narrow focus or a view that changes as the vehicle is driven.
85. The rollover detection system according to any one of embodiments 77-84, wherein the video from the video capture system is stored in a memory of a device.
86. The rollover detection system according to any one of embodiments 77-85, wherein the video from the video capture system is streamed to a third party device.
87. The rollover detection system according to any one of embodiments 77-86, wherein the video from the video capture system is streamed to a third party user.
88. The rollover detection system according to any one of embodiments 1-87, wherein the rollover detection system includes and automatically deploying rollover protective structure.
89. The rollover detection system according to embodiment 88, wherein the automatically deploying rollover protective structure deploys when a rollover is imminent.
90. The rollover detection system according to embodiment 88 or embodiment 89, wherein, the automatically deploying rollover protective structure protects a driver and/or a passenger.
91. The rollover detection system according to any one of embodiments 88-90, wherein automatically deploying rollover protective structure protects a component and/or part of a vehicle that is susceptible to damage due to a rollover.
92. The rollover detection system according to any one of embodiments 1-91, wherein the vehicle has a moving part.
93. The rollover detection system according to embodiment 92, wherein the moving part is a rear implement of a tractor; a shooting tower of a tank or other vehicle and/or the movable arm of an excavator.
94. The rollover detection system according to embodiment 92 or embodiment 93, wherein the moving part is used by the rollover detection system to prevent the vehicle from rolling over.
95. The rollover detection system according to any one of embodiments 1-94 that further includes a driver identification system.
96. The rollover detection system according to embodiment 95, wherein the driver identification system uses one or more parameter systems.
97. The rollover detection system according to embodiment 95, wherein the one or more parameter systems comprises fingerprint sensors, an RFID card identification system, a facial image recognition system and/or any system that can identify the individual driver.
98. The rollover detection system according to any one of embodiments 1-97, wherein the rollover detection system reduces the likelihood of a rollover by at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95% as compared to a vehicle driven without the rollover detection system to detect a potential rollover.
99. The rollover detection system according to any one of embodiments 1-97, wherein the rollover detection system reduces the likelihood of a rollover by, e.g., about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70% as compared to a vehicle driven without the rollover detection system to detect a potential rollover.
100. The rollover detection system according to any one of embodiments 1-97, wherein the rollover detection system increases the likelihood that a driver and/or a remote user is able to avoid a rollover by at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95% as compared to a vehicle driven without the rollover detection system to detect a potential rollover.
101. The rollover detection system according to any one of embodiments 1-97, wherein the rollover detection system increases the likelihood that a driver and/or a remote user is able to avoid a rollover by, e.g., about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70% as compared to a vehicle driven without the rollover detection system to detect a potential rollover.
102. The rollover detection system according to any one of embodiments 1-97, wherein the rollover detection system reduces the cost of operating a vehicle by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 30%, at least %, at least 40%, at least 45%, at least 50%, at least 55%, at least 60%, at least 65%, at least 70%, at least 75%, at least 80%, at least 85%, at least 90%, at least 95% or more.

### EXAMPLES

The following non-limiting examples are provided for illustrative purposes only in order to facilitate a more complete understanding of representative embodiments now contemplated. These examples should not be construed to limit any of the embodiments described in the present specification, including those pertaining to the rollover detection system disclosed herein, or methods or uses of the rollover detection system disclosed herein.

### Example 1

A driver of a truck carrying lumber is driven down a dirt road that was cut through a forest. The road contained ruts resultant from rain storms and frequent use by other trucks. The truck that is being driven has had a rollover detection system installed with a display comprising a bar with LED lights and an auditory verbal warning system. While the driver is driving the truck down the dirt road, the rollover detection system informs the driver that the truck is leaning to the left and a rollover warning is provided as the LEDs on the bar have lit up in a leftward direction going from the color green to yellow. At the same time, the driver is provided a verbal warning that begins to increase in volume and cadence as more yellow LED lights are lit informing the driver that a rollover risk exists and that failure to take corrective action may result in a rollover. The driver responds to the warning by taking a corrective action and moving the truck to a portion of the road that is flatter. As the driver undertakes the corrective action, the LED lights begin to shut off and the volume of the verbal warning gets lower and the cadence slower. After a few minutes, the truck is on a flat portion of the road. The LED lights are lit green and there is no additional verbal warning.

When the first warning of a rollover risk was triggered, a video camera located in the cabin and facing the driver was turned on and began to collect video of the driver and the driver's response. The video was sent in real-time to a server located at the site of a remote user who was able to watch the driver. Since the driver handled the situation correctly, the remote user did not have to intervene and take over control of the vehicle. However, if the driver did not take corrective action, the remote user had the ability to contact the driver and inform the driver on the proper corrective action. If this failed to correct the situation, the remote user had the ability to remotely take control of the truck and prevent a rollover.

While the driver was driving the truck, the data collected by the rollover detection system was sent in real time to the driver's supervisor's smartphone. The driver's supervisor had downloaded an application that provided the driver's supervisor with real-time data regarding the status of the truck. Normally, the supervisor checked their phone on a semi-regular basis. When the rollover detection system determined that there was a potential risk for a rollover, a warning was sent to the supervisor's smartphone, which when received caused the phone to vibrate and give off an audible tone. When the supervisor unlocked their phone, the supervisor was presented with a message to tap. When the supervisor tapped the message, the application opened and presented the supervisor information regarding the rollover risk of the truck being driven. The information was updated in real-time. The supervisor called the remote user to get more feedback on the rollover risk and agreed to allow the remote user to manage the situation. The supervisor hung up and reopened the application. As part of the application, the supervisor had the ability to stream the video from the truck's cabin. The supervisor turned on the video and watched the driver until the rollover risk ended.

A week later, the driver was brought in by the company the driver worked for to review the video of the situation related to the rollover risk. During this meeting, the driver was shown a video of their actions starting at the time a rollover risk was detected through the point that the rollover risk was ended. During the meeting, the driver was informed of corrective actions that the driver could have taken that the driver did not attempt. The driver was also informed of the steps that the driver could have taken to avoid the triggering of the system regarding a rollover risk.

The video of the driver was also used to prepare training material for the company to use to train new drivers. The video was used by the company to show how the driver avoided a potential rollover and other corrective actions that the driver could have taken.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Use of the terms “may” or “can” in reference to an embodiment or aspect of an embodiment also carries with it the alternative meaning of “may not” or “cannot.” As such, if the present specification discloses that an embodiment or an aspect of on embodiment may be or can be included as part of the inventive subject matter, then the negative limitation or exclusionary proviso is also explicitly meant, meaning that the an embodiment or an aspect of on embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1) A rollover detection system for the dynamic monitoring of the stability of a vehicle for detection of a rollover risk toward a vehicle first side and a vehicle second side, the rollover detection system comprises:
a controller with a processor and a memory, a data input for receiving a sensor signal comprising an acceleration event data and an inclination event data, and a data output for communicating a control signal;
a sensor system with one or more sensors for detecting an acceleration event and an inclination event, the sensor system in data communication with the controller through the data input for communicating the sensor signal to the controller; and
a warning system comprising a horizontal light bar divided into a first length section and a second length section, the warning system in data communication with the controller through the data output;
wherein the acceleration event data and the inclination event data are analyzed within the control device for determining a first illumination property of the first length section and a second illumination property of the second length section;
and wherein the first illumination property is changed by the controller if the rollover risk is detected toward the vehicle first side, the second illumination property is changed by the controller if the rollover risk is detected toward the vehicle second side;
and wherein the first illumination property is a first illuminated length of the first length section wherein the magnitude of the first illuminated length is proportional to the rollover risk toward the first side of the vehicle, and the second illumination property is a second illuminated length of the second length section wherein the magnitude of the second illuminated length is proportional to the rollover risk toward the second side of the vehicle.

2) The rollover detection system according to claim 1, wherein the sensor system receive GPS data and/or topography data.

3) The rollover detection system according to claim 1, wherein one or both of the acceleration event data and the inclination event data is selectable for use in the analysis of the rollover risk.

4) The rollover detection system according to claim 1, wherein the controller is separate from the warning system.

5) The rollover detection system according to claim 1, wherein a warning system further comprises an audible alarm.

6) The rollover detection system according to claim 5, wherein one or more of a volume, a tone, a cadence and a pitch of the audible alarm can remain constant, increase or decrease.

7) The rollover detection system according to claim 5, wherein one or more of the volume, the tone, the cadence and the pitch of the audible alarm alters to provide notification of the rollover risk.

8) The rollover detection system according to claim 1, wherein the device includes a means to provide information and/or data to a third party device.

9) The rollover detection system according to claim 8, wherein the means to send information is through a wireless device.

10) The rollover detection system according to claim 8, wherein the third party device is a cell phone, a computer system, a personal computer, a computer network, a cloud site, a tablet, a smartphone or a laptop.

11) The rollover detection system according to claim 8, wherein the third party device communicates information to the controller for communicating a corrective action or for remotely taking control of the vehicle.

12) The rollover detection system according to claim 1, wherein the controller periodically receives one or both a first data set from a first component and a second data set from a second component, one or both the first data set and the second data set being recorded in the memory.

13) The rollover detection system according to claim 12, wherein the first data set and the second data set is one or more of an accelerator pedal position, a braking pedal position, a braking system pressure value, a speedometer value, an RPM value, a steering wheel angle, a GPS position, or an inclinometer angle.

14) The rollover detection system according to claim 1, further comprises a video capture system.

15) The rollover detection system according to claim 1 that further includes a driver identification system.

16) The rollover detection system according to claim 1 wherein a center of the horizontal light bar is located between the first length section and the second length section, a first end of the first length section defined opposite the center, the first length section being lit sequentially from the center toward the first end to visually represent the rollover risk toward the first side of the vehicle, and a second end of the second length section defined opposite the center, the second length section being lit sequentially from the center toward the second end to visually represent the rollover risk toward the second side of the vehicle.

17) The rollover detection system according to claim 16 wherein the first length section comprises a first green section nearest the center, a first red section nearest the first end, and a first yellow section between the first green section and the first red section; and the second length section comprises a second green section nearest the center, a second red section nearest the second end, and a second yellow section between the second green section and the second red section.
